(19) United States
(12) Patent Application Publication
(10) Pub. No.: US 2014/0036808 A1
(43) Pub. Date: Feb. 6, 2014

(54) CONTROL OF UPLINK TRANSMISSION

(71) Applicant: INTERDIGITAL PATENT HOLDINGS, INC., Wilmington, DE (US)

(72) Inventors: Benoit Pelletier, Roxboro (CA); Paul Marinier, Brossard (CA); Diana Pani, Montreal (CA); Christopher Cave, Dollard-des-Ormeaux (CA)

(73) Assignee: INTERDIGITAL PATENT HOLDINGS, INC., Wilmington, DE (US)

(21) Appl. No.: 13/955,652

(22) Filed: Jul. 31, 2013

Related U.S. Application Data
(60) Provisional application No. 61/678,582, filed on Aug. 1, 2012.
(60) Provisional application No. 61/753,385, filed on Jan. 16, 2013.

(51) Int. Cl. H04W 72/14

(52) U.S. Cl. CPC H04W 72/14
USPC 370/329

(57) ABSTRACT

A dedicated grant may be shared by a group of WTRUs for performing uplink communications. A WTRU in a group may use the dedicated grant when it receives a group identifier and/or a WTRU identifier that are associated with the WTRU. The uplink communications from each WTRU transmitting in a group may be time-aligned. WTRUs may be allowed to transmit on the uplink channel using the dedicated grant for a designated time period. The WTRU may perform uplink control using MCS configurations controlled by the network. The WTRU may receive an indication of the MCS parameters or an MCS adjustment that may be applied to uplink communications. Uplink communications may be performed using an active non-scheduled transmission mode of operation or an inactive non-scheduled transmission mode of operation. Uplink load balancing may be performed by the network during dynamic frequency handover to manage the data packets being transmitted.

### CROSS-REFERENCE TO RELATED APPLICATIONS

This application claims the benefit of U.S. Provisional Patent Application No. 61/678,582, filed on Aug. 1, 2012, and U.S. Provisional Patent Application No. 61/753,385, filed on Jan. 16, 2013, the contents of which are incorporated by reference herein in their entirety.

### BACKGROUND

Wireless networks have received an increased demand for network resources. This increased demand has affected network communications on the uplink and the downlink. As multiple wireless transmit/receive units (WTRUs) may be communicating on the network at the same time, the demand may increase as the number of WTRUs on the network increases. Multiple WTRUs may even be associated with the same Node-B or other network entity, which may cause an increased demand for resources from a single network entity. The demand may also increase as the amount of information being requested by each WTRU increases.

Uplink communications and resources have been affected by the increased demand from WTRUs. WTRUs are sending more requests for information on the uplink. WTRUs are also sending larger files to the network on the uplink.

The increased demand on the uplink may cause noise rise variations at the network. Noise rise may occur when multiple WTRUs (e.g., via code-division multiplexing operations) are communicating with the network at the same time. The noise rise variations may be unpredictable, as the uplink communications may be uncoordinated. The increased noise rise may cause a loss in communications or inefficient communication with the network.

Network resources are also being used inefficiently due to unused resources that are reserved for uplink communications. The network may reserve resources for uplink communications and may send a grant to the WTRU for use of those resources. These grants may include scheduled or non-scheduled grants. While the network has reserved resources for the use of these grants by WTRUs, the grants may not be fully used or may be entirely unused by a WTRU.

### SUMMARY

Systems, methods, and apparatuses are described herein for control of uplink communications. The uplink transmit power may be controlled using a group identifier and/or a wireless transmit/receive unit (WTRU) identifier. A WTRU may be associated with a group of WTRUs that may share a dedicated grant on an uplink channel. A WTRU may receive the group identifier on a grant channel. The WTRU may receive the WTRU identifier on the grant channel. The WTRU identifier may indicate which WTRU within the group of WTRUs is allowed to use the dedicated grant on the uplink channel. The dedicated grant may be a HARQ-process dependent serving grant (HSG) that may be configured for one or more HARQ processes on the WTRU. The WTRU may determine whether it is allowed to use the dedicated grant on the uplink based on the group identifier and the WTRU identifier. If the group identifier and the WTRU identifier are associated with the WTRU, the WTRU may send information on the uplink channel using the dedicated grant. If the WTRU does not identify its group identifier and/or WTRU identifier on the grant channel, the WTRU may refrain from transmitting on the uplink channel using the dedicated grant.

Uplink communications from a WTRU may be time-aligned with WTRUs in other groups that may be communicating on the uplink. The WTRU may be allowed to send information on the uplink channel using the dedicated grant for a designated period of time. The period of time may be until the WTRU receives a group identifier or WTRU identifier that the WTRU does not recognize as being associated with the WTRU.

The WTRU may receive an indication to enable or disable the dedicated grant for a WTRU. The dedicated grant may be activated or deactivated (e.g., if enabled). When the dedicated grant is disabled or deactivated, the WTRU may use another serving grant. The dedicated grant may be enabled/disabled using a trigger.

The WTRU may perform uplink control using modulation/coding scheme (MCS) configurations that may be controlled by the network. The WTRU may receive an indication of MCS parameters that may be applied to uplink communications. The MCS parameters, or the location of the parameters, may be signaled by the network. The WTRU may perform a lookup of the MCS parameters in a local table based on an index received from the network. The WTRU may receive an MCS adjustment from a serving cell and may apply the MCS adjustment to uplink communications.

Uplink communications may be performed using an active non-scheduled transmission mode of operation or an inactive non-scheduled transmission mode of operation. When the WTRU has non-scheduled data to be transmitted, the WTRU may operate in an active non-scheduled transmission mode. When it is determined that the WTRU has not sent non-scheduled data for a period of time and/or does not have non-scheduled data for being transmitted, the WTRU may operate in an inactive non-scheduled transmission mode to allow the network to use unused resources. The WTRU may operate in an active non-scheduled transmission mode of operation and make a determination (e.g., dynamically) to move to an inactive non-scheduled transmission mode of operation. The determination may be made based on an indication from a Node-B or other network node, a level of non-scheduled data activity, and/or another triggering event.

Uplink load balancing may be performed by the network during dynamic frequency handover, e.g., to manage the data packets being transmitted. Uplink load balancing may be performed for a WTRU that supports uplink communication using multiple frequencies (e.g., dual cell HSUPA or multi-cell HSUPA). Various triggers may be implemented when performing dynamic frequency handover to balance the load on the uplink. The WTRU may execute the uplink frequency handover a predetermined amount of time after a trigger. The WTRU may execute the uplink frequency handover upon detection of the trigger or a predetermined amount of time after a trigger.

### BRIEF DESCRIPTION OF THE DRAWINGS

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and an example core network that may be used within the communications system illustrated in FIG. 1A.

FIG. 1E is a system diagram of another example radio access network and an example core network that may be used within the communications system illustrated in FIG. 1A.

FIG. 2 is a flow diagram illustrating an example for controlling uplink transmission power at a WTRU.

FIG. 3 is a flow diagram illustrating an example for changing the use of a dedicated serving grant from one WTRU to another.

FIG. 4A is a flow diagram that shows an example for adjusting modulation/coding scheme (MCS) transmissions at a WTRU.

FIG. 4B is a flow diagram that shows an example for applying MCS parameters that are indicated by a network entity.

FIG. 5 is a flow diagram that shows an example for operating in different non-scheduled transmission modes.

### DETAILED DESCRIPTION

A detailed description of illustrative embodiments is described with reference to the various figures. Although this description provides a detailed example of possible implementations, the details are intended to be exemplary and in no way limit the scope of the application. In addition, the figures may illustrate call flows and/or flow diagrams, which are meant to be exemplary. Other embodiments may be used. The order of the messages/flows may be varied where appropriate. Messages/flows may be omitted if unused, and, additional messages/flows may be added.

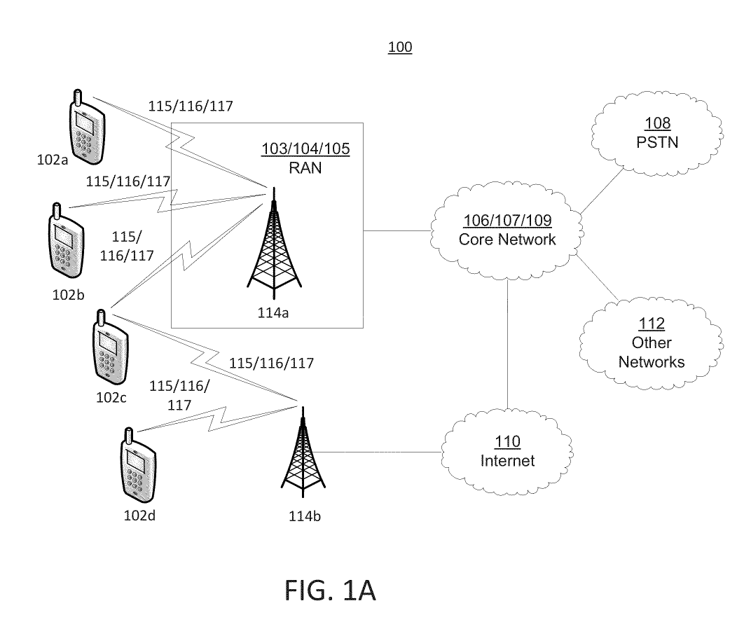

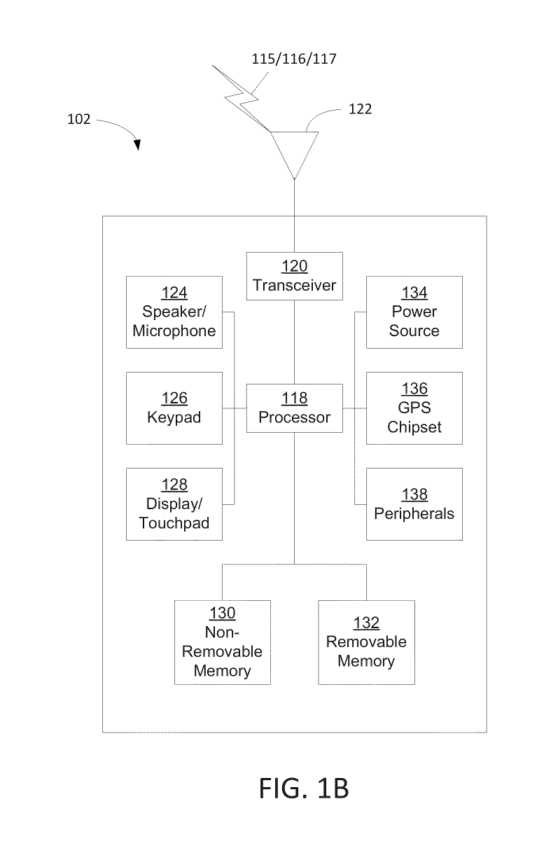

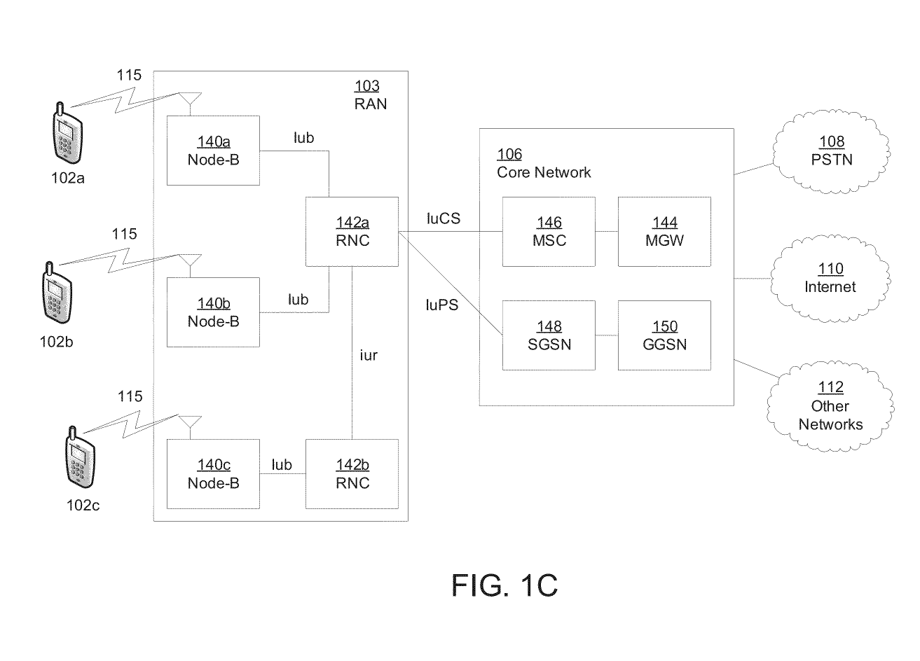

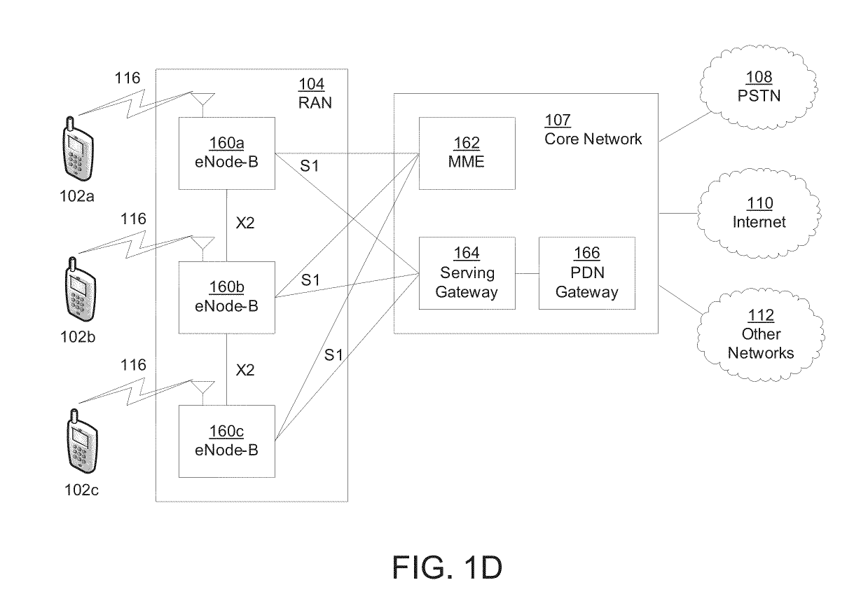

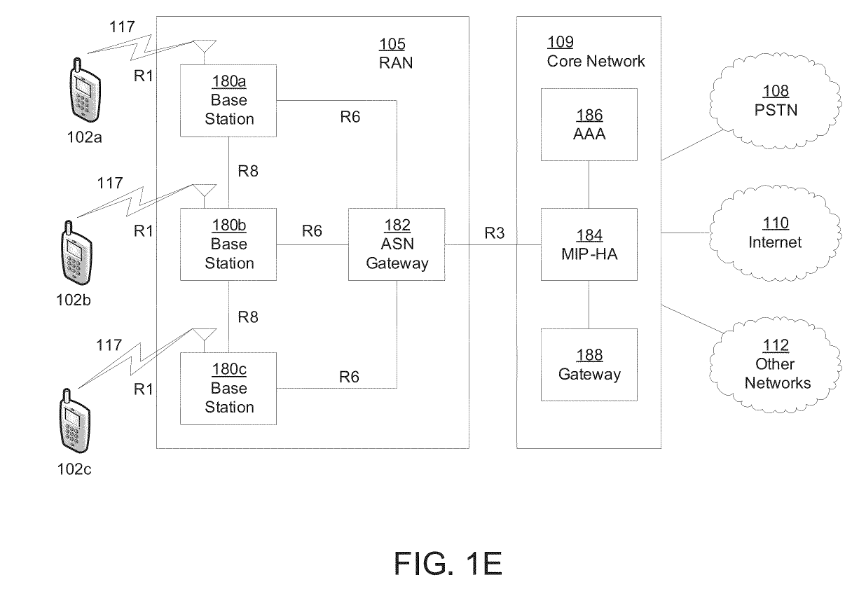

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and/or the like.

As shown in FIG. 1A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and/or other networks 112, though any number of WTRUs, base stations, networks, and/or network elements may be used. Each of the WTRUs 102a, 102b, 102c, 102d may be any type of device configured to operate and/or communicate in a wireless environment. By way of example, the WTRUs 102a, 102b, 102c, 102d may transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and/or the like.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and/or the like. While the base stations 114a, 114b are each depicted as a single element, the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and/or the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and/or the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and/or the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106/107/109.

The RAN 103/104/105 may be in communication with the core network 106/107/109, which may be any type of network configured to provide voice, data, video, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 1A, the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138. The WTRU 102 may include any sub-combination of the elements described herein. Also, the base stations 114a and 114b, and/or the nodes that base stations 114a and 114b may represent, such as but not limited to transceiver station (BTS), a Node-B, a site controller, an access point (AP), a home node-B, an evolved home node-B (eNode-B), a home evolved node-B (HeNB), a home evolved node-B gateway, and proxy nodes, among others, may include some or all of the elements depicted in FIG. 1B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and/or the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, the processor 118 and the transceiver 120 may be integrated together in an electronic package or chip.

The transmit/receive element 122 may be configured to transmit signals to, and/or receive signals from, a base station (e.g., the base station 114a) over the air interface 115/116/117. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. The transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and/or to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, and/or any other type of memory storage device. The removable memory 132 may include a subscriber identity module (SIM) card, a memory stick, a secure digital (SD) memory card, and/or the like. In other embodiments, the processor 118 may access information from, and/or store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and/or the like.

The processor 118 may be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. The WTRU 102 may acquire location information by way of any suitable location-determination method.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and/or the like.

FIG. 1C is an example system diagram of the RAN 103 and the core network 106. As described herein, the RAN 103 may employ a UTRA radio technology to communicate with the WTRUs 102a, 102b, 102c over the air interface 115. The RAN 103 may also be in communication with the core network 106. As shown in FIG. 1C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. The RAN 103 may include any number of Node-Bs and RNCs.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. Each of the RNCs 142a, 142b may be configured to carry out or support other functionality, such as outer loop power control, load control, admission control, packet scheduling, handover control, macrodiversity, security functions, data encryption, and/or the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may be connected to the networks 112, which may include other wired or wireless networks that are owned and/or operated by other service providers.

FIG. 1D is an example system diagram of the RAN 104 and the core network 107. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though the RAN 104 may include any number of eNode-Bs. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and/or the like. As shown in FIG. 1D, the eNode-Bs 160a, 160b, 160c may communicate with one another over an X2 interface.

The core network 107 shown in FIG. 1D may include a mobility management gateway (MME) 162, a serving gateway 164, and/or a packet data network (PDN) gateway 166. While each of the foregoing elements are depicted as part of the core network 107, any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and/or the like. The MME 162 may provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may perform other functions, such as anchoring user planes during inter-eNode B handovers, triggering paging when downlink data is available for the WTRUs 102a, 102b, 102c, managing and storing contexts of the WTRUs 102a, 102b, 102c, and/or the like.

The serving gateway 164 may be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. The core network 107 may provide the WTRUs 102a, 102b, 102c with access to the networks 112, which may include other wired or wireless networks that are owned and/or operated by other service providers.

FIG. 1E is an example system diagram of the RAN 105 and the core network 109. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 1E, the RAN 105 may include base stations 180a, 180b, 180c, and/or an ASN gateway 182, though the RAN 105 may include any number of base stations and ASN gateways. The base stations 180a, 180b, 180c may each be associated with a particular cell (not shown) in the RAN 105 and may each include one or more transceivers for communicating with the WTRUs 102a, 102b, 102c over the air interface 117. The base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may provide mobility management functions, such as handoff triggering, tunnel establishment, radio resource management, traffic classification, quality of service (QoS) policy enforcement, and/or the like. The ASN gateway 182 may serve as a traffic aggregation point and may be responsible for paging, caching of subscriber profiles, routing to the core network 109, and/or the like.

The air interface 117 between the WTRUs 102a, 102b, 102c and the RAN 105 may be defined as an R1 reference point, which may implement the IEEE 802.16 specification. Each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that may include protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 105 may be connected to the core network 109. The communication link between the RAN 105 and the core network 109 may defined as an R3 reference point that may include protocols for facilitating data transfer and mobility management capabilities, for example. The core network 109 may include a mobile IP home agent (MIP-HA) 184, an authentication, authorization, accounting (AAA) server 186, and/or a gateway 188. While each of the foregoing elements are depicted as part of the core network 109, any one of these elements may be owned and/or operated by an entity other than the core network operator.

The MIP-HA 184 may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and land-line communications devices. The gateway 188 may provide the WTRUs 102a, 102b, 102c with access to the networks 112, which may include other wired or wireless networks that are owned and/or operated by other service providers.

Although not shown in FIG. 1E, the RAN 105 may be connected to other ASNs and/or the core network 109 may be connected to other core networks. The communication link between the RAN 105 and the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

The above-referenced communications systems may be implemented as described herein. The communications systems, or portions thereof, may be used to control uplink communications. The transmit power of uplink communications may be controlled using serving grants. A serving grant may be a dedicated grant or other transmission power grant. A serving grant may be used by a single WTRU at a time. A Node-B may send a serving grant to a WTRU indicating a predetermined level at which the WTRU may transmit. The predetermined level may include an absolute value (e.g., 10 db) or a relative value (e.g., 10 db above a previous serving grant level). The absolute grant value may be a fixed number value that may be signaled to a WTRU for transmitting at the signaled level. The relative grant value may include a relative value that may be used to increase or decrease a transmission level at the WTRU by the received value. The serving grant may be used by the Node-B to control the noise in the network.

While a serving grant may be used to control the transmission power at a WTRU, a WTRU may receive a non-serving grant from another network entity (e.g., a neighboring network entity). The non-serving grant may be similar to the serving grant, but may be received from a non-serving network entity, such as a non-serving Node-B. The non-serving grant may be an absolute grant or a relative grant. For example, if a WTRU is creating interference in a non-serving neighbor cell, the neighbor cell may request a relative grant to decrease the level of transmission sent from the WTRU.

WTRUs, such as smartphones or other WTRUs, may run one or more applications (e.g., concurrently) that may create a demand on the network by transmitting information on the uplink. The applications may be updated via various network updates. These updates may be performed to ensure proper communications. The application updates may be requested on an uplink channel. An uplink channel may include an enhanced dedicated channel (E-DCH), physical radio access channel (PRACH), dedicated channel (DCH), or other uplink channel.

WTRUs may send other types of data on the uplink channel. A WTRU may upload media data to the network on the uplink channel. The uploading of media data from WTRUs may create a demand on the uplink. A WTRU may upload pictures and/or movies to social networks or cloud services, which may create a demand on the uplink. The transmission of data on the uplink may be larger than anticipated by some network configurations. When the uplink communications exceed a predetermined level, the uplink channel (e.g., E-DCH) may become a bottleneck for capacity. The uplink channel (e.g., E-DCH) may be implemented as described herein to sustain the uplink demand of WTRUs.

The uplink channel may include a dedicated channel for wireless communications, such as the E-DCH. The E-DCH may include an HSUPA channel. The E-DCH may support 10 ms and 2 ms transmission time interval (TTI) or subframe, and/or synchronous hybrid-ARQ (HARD) and power-based scheduling. WTRUs transmitting with the E-DCH may be power-controlled for each communication slot. The power control may be performed using CDMA, such as WCDMA. Power control may be implemented for CDMA operations and the power control loop may be controlled by Node-Bs in the active set associated with the WTRU. While E-DCH and/or HSUPA may be implemented as described herein, other channel types or communication types may be similarly implemented.

In WCDMA, the noise rise may be controlled by the network. For each user added to the network, additional noise may be added to the network. A higher noise rise value on a network may result in each user having to transmit at a higher power level to overcome the higher noise level. As the users increase their transmit power, a smaller path loss may be tolerated by the network and the effective cell radius may be reduced for the uplink, which may limit the uplink coverage. Each WTRU may be allocated a portion of the noise rise. The dedicated physical control channel (DPCCH) may be used as a reference channel and each WTRU may be allocated a portion of the transmit power above the DPCCH.

WCDMA may be designed such that multiple WTRUs may transmit at the same time. The Node-B may be able to decode the CDMA signals transmitted from one or more WTRUs. As the number of simultaneously transmitting WTRUs increases, the noise rise may increase and/or the corresponding cell size may shrink. This behaviour may be referred to as cell breathing. High noise rise may be problematic because it may create instability. The noise rise may make scheduling more difficult and/or may reduce system coverage due to an effective shrinking of the cell. High noise rise may be an issue for single or multi-user detection.

Multiple users creating a high noise rise may be exacerbated by smartphones or other WTRUs that may create (e.g., in an unpredictable way) a large number of data packets on the uplink. Many WTRUs may be transmitting simultaneously on the uplink channel (e.g., E-DCH). Networks may rely on load balancing across multiple uplink frequencies. Uplink frequency handovers may be used to perform such load balancing. The time for performing a frequency handover may be slower than other load balancing techniques. As more WTRUs are transmitting on the uplink, the time for performing a handover at each WTRU may be delayed. By the time a handover takes place for a WTRU, the WTRU may have completed its uplink transmission, which may cause unnecessary signaling on the system.

Time-division multiplexing may be used to mitigate effects of the high noise rise in a multi-user environment. HSUPA may be implemented using CDMA as a basis for user multiplexing. As such, HSUPA control mechanisms may be designed for code-division multiplexing. In the uplink (e.g., E-DCH), WTRUs may be aligned at the subframe level. Multiple WTRUs may be configured in a cell such that their subframe boundaries may be time-aligned, or may be overlapping within the same time period. Combined with HARQ process activation/deactivation, a TTI in the uplink (e.g., 2 ms TTI E-DCH) may be implemented in TDMA operations, with a WTRU transmitting on the uplink per each subframe.

Downlink control signaling may be implemented to support time-aligned operations in the uplink. While WTRUs may be aligned at the subframe-level on the uplink, such time-alignment may be imprecise for optimal demodulation at the Node-B. The time-alignment may be imprecise due to overlapping subframes. Uplink frequency handovers may be slower than other load balancing techniques.

Serving grants, HARQ processes, and/or other transmission parameters may be used to control uplink transmissions and balance the load on a network. Per-HARQ process serving grant control may be implemented at a WTRU. The WTRU may be configured with one or more HARQ process dependent serving grants (HSGs). An HSG may be configured via RRC signaling from the network. When executing E-DCH transport format combination (E-TFC) selection, the WTRU may determine whether or not a HARQ process is configured with an HSG. When a HARQ process is configured with an HSG, the WTRU may use the value of the HSG for the serving grant when executing the E-TFC selection. When a HARQ process is not configured with an HSG, the WTRU may be configured to use another type of serving grant, such as a non-HSG or other non-dedicated serving grant. The non-HSG serving grant may be common to each HARQ process at a WTRU not configured with an HSG serving grant.

An HSG may include a variable having a value of the HARQ process specific serving grant. A WTRU may have HSG operations enabled when at least one HSG is configured. Otherwise, HSG operations may be disabled. If the HSG operations are disabled, the WTRU may use another serving grant (e.g., a non-HSG) for HARQ processes.

HSG operations, if enabled, may be activated/deactivated. The HSG operations may be activated/deactivated via layer 1 (L1) and/or layer 2 (L2) messaging. The HSG operations may be activated/deactivated via high-speed shared control channel (HS-SCCH) orders and/or medium access control (MAC) level indications. When HSG operations are activated, the WTRU may use the HSG. When HSG operations are deactivated, the WTRU may use another type of serving grant (e.g., a non-HSG or other non-dedicated serving grant). The WTRU may be configured with an HSG for each HSG-enabled HARQ process or an HSG common to HSG-enabled HARQ processes at the WTRU.

HSG operations may be activated/deactivated on a per-HARQ process basis. HSG operations may be activated/deactivated for HARQ processes jointly or globally (e.g., across HSG enabled operations). When the WTRU receives a trigger for per-HARQ process activation, the WTRU may activate HSG operations for the associated HARQ process. The WTRU may deactivate HSG operations for the associated HARQ process upon reception of a per-HARQ process deactivation trigger. When the WTRU receives a trigger for global HSG operations activation, the WTRU may activate HSG operations on the HSG-enabled HARQ processes at the WTRU. The WTRU may deactivate HSG operations on the HSG-enabled HARQ processes upon reception of a global HSG operation deactivation trigger.

L1 triggers may be used for activation and/or deactivation. L1 triggers may be communicated via an HS-SCCH order and/or an E-DCH Absolute Grant Channel (E-AGCH). The WTRU may receive an L1 message (e.g., via an HS-SCCH order, E-AGCH, etc.) or other message for HSG activation/deactivation. E-DCH-related control messages may be carried on the E-AGCH. The control of HSG operations may be carried on the HS-SCCH. The control of HSG operations may be carried out on the HS-SCCH to receive the protection offered by the ACK/NACK that may be sent upon reception of the HS-SCCH by the WTRU.

The control of HSG operations may be carried out on another type of physical channel. The channel on which HSG control may be carried out may include an HS-SCCH, or a channel similar to an HS-SCCH channel. A channel similar to an HS-SCCH on which HSG control may be carried out may be referred to as an HARQ-process dependent serving grant shared control channel (HSG-SCCH). The HSG-SCCH may be based on the HS-SCCH. The HSG-SCCH may have encoding that is the same as, or similar to, the HS-SCCH, a structure that is the same as, or similar to, the HS-SCCH, and/or the like. The channel on which HSG control may be carried out may include an E-AGCH, or a channel similar to an E-AGCH. A channel similar to an E-AGCH on which HSG control may be carried out may be referred to as an E-DCH HARQ-process dependent absolute grant channel (E-HAGCH). The E-HAGCH may be based on the E-AGCH. The E-HAGCH may have encoding that is the same as, or similar to, the E-AGCH, a structure that is the same as, or similar to, the E-AGCH, and/or the like.

The HSG order may carry explicit per-HARQ process activation/deactivation indications. The HSG order may carry an explicit indication for each HARQ process to be activated or deactivated for HSG operations. The explicit indication may be indicated by one or more bits. The WTRU may receive one or more bits for each HARQ process. As an example, where 8 HARQ processes are used by the WTRU, 8 bits may be used to carry the activation/deactivation information. A value (e.g., a value of “1”) may indicate activation of HSG operations, whereas another value (e.g., a value of “0”) may indicate deactivation of HSG operations for a HARQ process. The WTRU may be configured to ignore bits associated with HSG-disabled HARQ processes.

The HSG order may carry a per-HARQ process HSG activation/deactivation indication. The WTRU may determine the target HARQ process implicitly via the timing of the HSG order. The target HARQ process may be determined by associating the HARQ process that occurred a number of TTIs (e.g., eight TTIs) before the reception of the HSG order. In such cases, the HSG order may carry one or more bits for the activation/deactivation message (e.g., value of “1” may correspond to activation whereas value of “0” may correspond to deactivation).

The HSG order may carry an HSG global activation/deactivation indication. The WTRU in such cases may apply the activation/deactivation to HSG-enabled HARQ processes at the WTRU. This may be implemented when the HSG order is determined implicitly based on timing. For example, a HARQ process that occurred a number of TTIs (e.g., eight TTIs) before the reception of the HSG order may be associated with the HSG order and the indication in the HSG order may be applied to the HARQ process.

The WTRU may be configured to activate and/or deactivate HSG operations based on the received value of the HSG. For example, the WTRU may receive an HSG value via an E-AGCH, an E-HAGCH, an HS-SCCH, an HSG-SCCH, or other channel similar to or based on HS-SCCH or E-AGCH. The channel on which the HSG value may be received may carry one or more of an activation indication (e.g., HARQ-dependent or global), an HSG value index (e.g., HARQ-dependent or global), a WTRU target identity (e.g., radio network temporary identifier (RNTI)), and/or a scope indication (e.g., global, per-HARQ, etc.). The HSG value index may point to a table of HSG values. The table of HSG values may include a list of grant values for performing uplink transmissions.

The WTRU may implement the grant value based on a DEACTIVATE value, an ACTIVATE value, a ZERO grant value, and/or the like. These values may be included in the table of HSG values. Upon reception of a DEACTIVATE grant value, the WTRU may deactivate HSG operations. The DEACTIVATE grant value may be applied to a related HARQ process or processes, or globally to each HARQ process. Upon reception of an ACTIVATE grant value, the WTRU may activate HSG operations. The ACTIVATE grant value may be applied to a related HARQ process or processes, or globally to each HARQ process. Upon reception of the ZERO grant value, the WTRU may stop uplink (e.g., E-DCH) transmission on the relevant HARQ process(es). The ZERO grant value may be applied to a related HARQ process or processes, or globally to each HARQ process.

The WTRU may determine the scope of application (e.g., per HARQ process or global) of the DEACTIVATE grant value, the ACTIVATE grant value, and/or the ZERO grant value based on a separate scope indicator. The scope indicator may include a scope indicator bit. The scope indicator may indicate whether the DEACTIVATE grant value, the ACTIVATE grant value, and/or the ZERO grant value is applied to a HARQ process or processes, or globally to each HARQ process at the WTRU. A common scope indicator may be applied to the DEACTIVATE grant value, the ACTIVATE grant value, and the ZERO grant value, or each value may be associated with a scope indicator.

L2 triggers may be used for activation and/or deactivation of the HSG at a WTRU. L2 triggers may be communicated via MAC signaling. The WTRU may receive a MAC message. The MAC message may carry a per-HARQ process HSG activation/deactivation indication and/or a global HSG activation/deactivation. The WTRU may receive the activation/deactivation indication on a MAC header, such as a MAC-ehs or MAC-hs header.

Various WTRU actions may be triggered upon reception of an HSG operation activation trigger for one or more HARQ processes. Upon receipt of the activation trigger for the HSG operation, the WTRU may apply the HSG value to transmissions in the relevant HARQ processes. When the WTRU receives the HSG activation trigger, the HSG activation may be ACKed. The WTRU may send an ACK to the network. The ACK may be sent using an HS-SCCH order or an HSG order. The WTRU may apply the HSG value after receiving the activation trigger. The WTRU may wait a predetermined amount of time after receiving the activation trigger before applying the HSG value. The WTRU may wait for the ACK to be received by the network before applying the HSG value. The WTRU may wait for the ACK to be received by the network if the HSG value is larger than the current serving grant value that the WTRU is implementing. Otherwise, the WTRU may apply the HSG value upon receipt of the activation trigger.

Various WTRU actions may be performed upon reception of an HSG operation deactivation trigger for one or more HARQ processes. The WTRU may apply a serving grant to transmissions for the relevant HARQ processes. When HSG operation is activated, the HSG may be applied. When HSG operation is deactivated, a non-HSG may be applied. When the WTRU receives the HSG deactivation trigger, the HSG deactivation may be ACKed. The WTRU may send an ACK to the network. The ACK may be sent using an HS-SCCH order. The WTRU may apply the serving grant value (e.g., a non-HSG value or other non-dedicated serving grant value) after receiving the deactivation trigger. The WTRU may wait a predetermined amount of time before applying the serving grant value. The WTRU may wait for the ACK to be received by the network before applying the serving grant value. The WTRU may wait for the ACK to be received by the network if the serving grant value (e.g., a non-HSG value or other non-dedicated serving grant value) is larger than the current HSG value. Otherwise, the WTRU may apply the serving grant value (e.g., a non-HSG value or other non-dedicated serving grant value) upon receipt of the deactivation trigger.

The WTRU may update the HSG values. When HSG operations are enabled, the WTRU may maintain and/or remember the value of other serving grants (e.g., a non-HSG value or other non-dedicated serving grant value). The WTRU may maintain the serving grant (e.g., a non-HSG value or other non-dedicated serving grant value) when at least one HARQ process is not HSG enabled. When HSG operations are enabled, the WTRU may maintain one or more HSG values. The WTRU may monitor one or more grant channels for the HSG. A channel on which the HSG may be monitored may include the E-HAGCH. The WTRU may update the HSG value being implemented based on the received HSG value on the grant channel.

The WTRU may receive an absolute HSG value over the grant channel. The same, or similar, encoding used for the E-AGCH may be used for the E-HAGCH. The E-HAGCH may be carried on a separate downlink channelization code than the E-AGCH. The WTRU may determine that the grant channel carries HSG information based on a detected RNTI value, such as the E-DCH RNTI (E-RNTI). The WTRU may be configured with an E-RNTI value used to indicate that the grant channel carries HSG information. This E-RNTI value may be referred to as the HSG E-RNTI. The WTRU may monitor the grant channel for the HSG E-RNTI value. When the WTRU detects that its HSG E-RNTI is carried on the grant channel, it may determine that the channel carries HSG information for the WTRU. The WTRU may decode the information on the grant channel accordingly.

The WTRU may monitor relative HARQ process dependent relative grant updates. The relative HSG may operate in similar ways as other relative grants (e.g., non-HSG grants). The relative HSG may be carried on a channel similar to the E-DCH relative grant channel (E-RGCH), which may be referred to as the E-DCH HSG relative grant channel (E-HRGCH). The E-HRGCH may be carried on a separate downlink channelization code than the E-RGCH. The E-HRGCH may be carried on the same channelization code as the E-RGCH. The E-HRGCH may use a distinct signature sequence from the E-RGCH, such as when carried on the same channelization code for example.

The WTRU may receive the grant channel from a serving and/or non-serving radio link sets (RLS). The grant channel may include a relative grant channel. The WTRU may receive HSG UP and/or HSG DOWN commands from the serving RLS. Upon reception of HSG UP commands, the WTRU may increase the appropriate HSG value. Upon reception of HSG DOWN commands, the WTRU may decrease the appropriate HSG value. The HSG value may be increased or decreased by a predetermined amount stored at the WTRU. The predetermined amount may be included in a table stored at the WTRU. The upon receiving an HSG UP or HSG DOWN command, the WTRU may move to the next index in the table stored at the WTRU. The HSG value may be applied globally or for an associated HSG-enabled HARQ process or processes. The WTRU may apply the command received from the serving RLS to an HSG value associated with an HSG-enabled HARQ process. The WTRU may apply the command to the HSG-enabled HARQ process based on the timing of the received relative grant channel (e.g., the HARQ process that occurred a number of TTIs prior).

The WTRU may receive HSG DOWN commands from a non-serving RLS. Upon reception of the HSG DOWN command, the WTRU may decrease the appropriate HSG value (e.g., if configured or if applicable). The HSG value may be decreased by a predetermined amount stored at the WTRU (e.g., next index in a table stored at the WTRU). The HSG values may be decreased globally or for an associated HSG-enabled HARQ process or processes. The HARQ process or processes to which the HSG value may be applied may be the activated HARQ process or processes. The relative grant channel may be sent using about an 8 ms TTI.

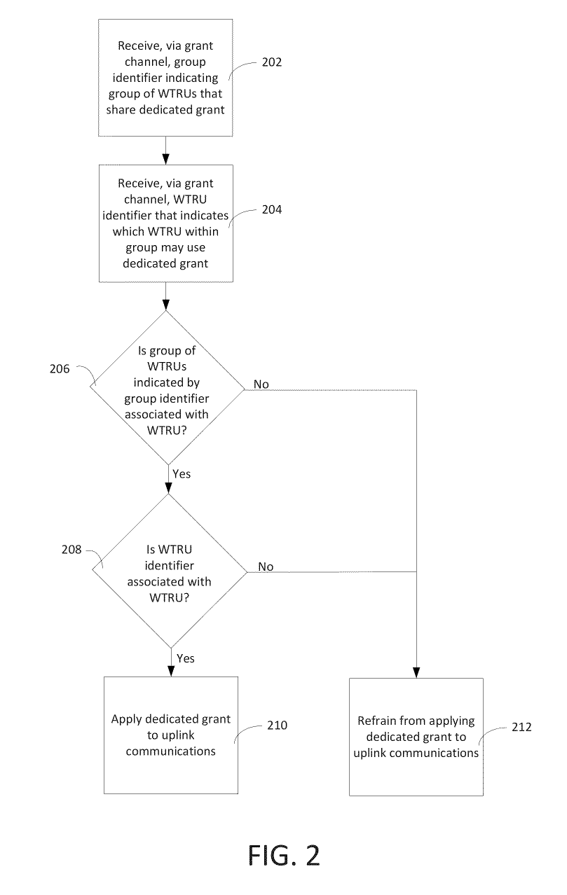

FIG. 2 is a flow diagram illustrating an example for controlling uplink transmission power at a WTRU. As shown in FIG. 2, at 202 a group identifier may be received via a grant channel. The group identifier may indicate a group of WTRUs that may share a dedicated grant on an uplink channel. The group identifier may include an E-RNTI value. The WTRU may be configured with an E-RNTI that may be shared with one or more WTRUs.

The WTRU may monitor a physical layer channel or a control channel for a bit or bits that indicate the group identifier. The physical layer channel or control channel may include a grant channel, such as an E-AGCH or E-HAGCH. The grant channel may carry Nₘₐₓ group identification bits. Nₘₐₓ may refer to a maximum group size (e.g., Nₘₐₓ=4).

At 204, a WTRU identifier may be received. The WTRU identifier may indicate which WTRU within the group of WTRUs indicated at 202 is allowed to use the dedicated grant on the uplink channel. The WTRU may be configured with a unique identity for a group to which it is associated. The WTRU may monitor for the associated value in the WTRU group identification field. The WTRU identifier may be referred to as a WTRU_{gid} (e.g., WTRU_{gid}=2). The WTRU_{gid} may be the identifier of the WTRU within the group of Nₘₐₓ, where WTRU_{gid}=1, . . . , Nₘₐₓ.

The WTRU may monitor a physical layer channel or a control channel for a bit or bits that indicate the WTRU_{gid}. The physical layer or control layer channel may be the same channel, or similar type of channel, on which the group identifier may be received. When the WTRU_{gid} is indicated by a bit or bits, the WTRU may monitor the channel for a value of the bit or bits that indicate its WTRU_{gid}.

The WTRU may determine whether or not it is assigned the group resource based on whether the WTRU identifies the group identifier for the group with which it is associated and/or its WTRU_{gid} (or WTRU identifier within the group). At 206, the WTRU may determine whether the group identifier received at 202 is associated with the WTRU. At 208, the WTRU may determine whether the WTRU identifier received at 204 is associated with the WTRU. If the WTRU identifies its group identifier at 206 and/or its WTRU_{gid} at 208, the WTRU may apply the dedicated grant value received in the grant channel, or other control channel, and may send information on the uplink channel using the dedicated grant at 210. If the WTRU fails to identify its group identifier at 206 and/or fails to identify its WTRU_{gid} at 208, the WTRU may refrain from applying the dedicated grant value to the uplink channel at 212. For example, if the WTRU determines that its WTRU identifier is not included in the received signal, or identifies another WTRU identifier in the received signal, the WTRU may refrain from applying the dedicated grant value to the uplink channel.

The dedicated grant value may be an HSG value, which may be used for one or more HARQ processes at the WTRU. The E-RNTI that identifies the group may be referred to as an HSG Group E-RNTI (HSG-G-E-RNTI). The WTRU may apply the HSG value received in the control channel for the relevant HARQ process(es). The HSG value may be applied to each HARQ process on the WTRU, or one or more HARQ process on the WTRU may be configured with a different HSG value. The WTRU may be configured explicitly with a HARQ process number in a configuration message. In another example, the WTRU may determine the HARQ process number based on the timing of the configuration message (e.g., the HARQ process that occurred a number of TTIs prior).

An activation/deactivation value may be used to indicate whether to apply the dedicated grant value at a WTRU. The activation/deactivation value may be a bit value that may be used to indicate whether to apply the dedicated grant value for a WTRU_{gid}. If a bit value associated with the WTRU_{gid} is set to an activation value (e.g., a value of “1”), the WTRU having the WTRU_{gid} may apply the dedicated grant value received in the control channel for the relevant HARQ process(es). If the WTRU does not recognize its WTRU_{gid} and/or an activation value associated with its WTRU_{gid} on the grant channel or control channel, the WTRU may set the dedicated grant value to “0” the for the relevant HARQ process(es).

The WTRU group identification bits may be interpreted as explicit activation/deactivation indications for one or more WTRUs in a control message (e.g., an L1 control message). The control channel for dedicated grant group operations may carry one or more fields that may be used to indicate the dedicated grant value, a group of WTRUs to which the dedicated grant value may be applied, the WTRU within the group that may use the dedicated grant, an activation status value, and/or a scope indicator that may indicate the scope of application of the dedicated grant value. When the dedicated grant is an HSG, the one or more of fields may include an HSG value, an HSG-G-E-RNTI, an Activation Group Status (AGS), and/or an HSG scope indicator. The AGS may carry the identity value for the WTRU for which the HSG value may apply. The identity value may include an index configured by the network. When the WTRU determines that the AGS corresponds to its pre-configured identity value within the group, the WTRU may activate or deactivate the associated HSG-enabled HARQ process or processes.

The AGS may carry up to Nₘₐₓ bits that may support up to Nₘₐₓ WTRUs for each control channel. Each WTRU in the group may monitor the HSG-G-E-RNTI and/or a bit in the AGS (e.g., the bit indexed with the WTRU_{gid}), which may indicate the activation or deactivation status of the associated HSG-enabled HARQ process or processes. The HSG scope indicator may indicate whether the activation or deactivation status is applied globally or to a HARQ process or processes. The HSG scope indicator, or a HARQ process identifier associated with the scope indicator, may indicate the HSG-enabled HARQ process or processes to which the activation/deactivation may be applied. When an HSG-enabled HARQ process is deactivated, the WTRU may flush the buffer of the HARQ process being deactivated and/or reset the HARQ process being deactivated.

The Node-B may be configured with a group of WTRUs for which an HSG may be applied. The Node-B may receive the groups of WTRUs from the RNC. The WTRU identities may be associated with an HSG-G-E-RNTI or other WTRU identifier. Each WTRU in a group may have another identity value that may identify the group to which it is associated.

Resource allocation may be performed using time-aligned uplink operations. For time-aligned uplink operations, the network may change dynamically which WTRU may have access to an HARQ process or E-DCH TTI. This way, the TDM resource usage may be increased and/or maximized. Serving grant operations may be implemented to change the use of a serving grant from one WTRU to another.

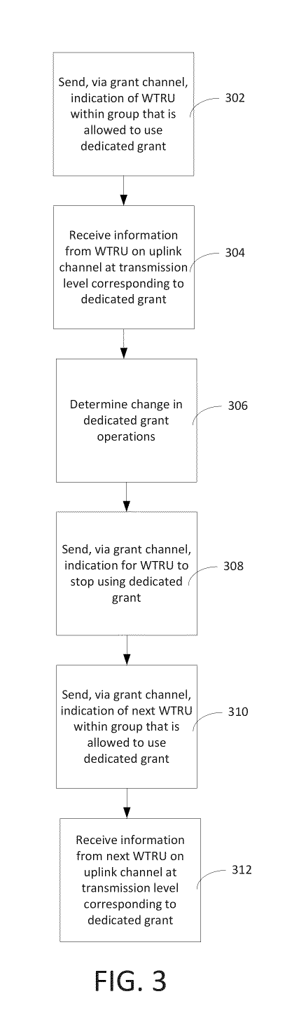

FIG. 3 is a flow diagram illustrating an example for changing the use of a dedicated serving grant from one WTRU to another. Each WTRU within a group of WTRUs may be able to use the dedicated grant for a period of time that may be exclusive to the WTRU in the group. The time period for multiple groups may be aligned to allow time-aligned uplink communications among groups of WTRUs. As shown at 302, a network entity (e.g., a Node-B) may send an indication of a WTRU within a group of WTRUs that is allowed to use a dedicated grant. The dedicated grant may be shared by the WTRUs within the group (e.g., the WTRUs in the group may take turns using the dedicated grant, for example as assigned by the network). The indication may include the WTRU_{gid} of the WTRU within the group that may be allowed to use the dedicated grant and/or an activation indication. At 304, the network entity may receive information from the WTRU on an uplink channel (e.g., E-DCH) at the transmission level corresponding to the dedicated grant value.

At 306, the network entity may decide to change the dedicated grant operations. The dedicated grant operations may be changed from one WTRU to another after a period of time. The period of time may be determined dynamically or may be pre-determined. To change the dedicated grant operations from the WTRU that is allowed to use the dedicated grant, the network entity may send an indication for the WTRU to stop using the dedicated grant at 308. The indication sent at 308 may be sent via the grant channel or another control channel. After receiving this indication, the WTRU currently using the dedicated grant may set the dedicated grant value to zero and/or may use another grant value for uplink transmissions.

The network entity may send, at 310, an indication of a next WTRU within the group that is allowed to use the dedicated grant. The indication may be sent via the grant channel. The indication may include the WTRU_{gid} of the next WTRU that may use the dedicated grant and/or an activation indication. The indication sent at 308 for the WTRU to stop using the dedicated grant and the indication sent at 310 for the next WTRU to use the dedicated grant may be the same indication. The WTRU_{gid} and/or the activation indication sent at 310 may be sent to stop a WTRU from using the dedicated grant and allow another WTRU to use the dedicated grant. The next WTRU identified by the network entity may set its dedicated grant value to the power transmission value indicated by the network for using the dedicated grant. At 312, the network entity may receive information from the WTRU on the uplink communication channel at the transmission level corresponding to the dedicated grant.

Where the dedicated grant includes an HSG, HSG operations may change an HSG from one WTRU to another. Each WTRU within a group of WTRUs may be able to use the HSG, or another dedicated grant, for a period of time that may be exclusive to the WTRU in the group. When implementing a change in HSG operations, the WTRU that is using an HSG may receive an indication to stop using the HSG. The indication may be an identifier of another WTRU to which the HSG may be granted use by the network. After receiving this indication, the WTRU currently using the HSG may set the HSG value to zero. The next WTRU identified by the network may set its HSG value to the power transmission value indicated by the network for using HSG.

The use of a dedicated grant by a group of WTRUs may be achieved with one or more grant channels (e.g., one or more E-AGCH or E-HAGCH signals). Each WTRU may listen to a different grant channel, or the WTRUs in a group may listen to the same grant channel in a cell. The grant channel may be transmitted at a TTI (e.g., any TTI). The latency associated with changing the resource from one WTRU to another may cause degradation in network resource usage. Such resource swaps may be performed using a TTI.

In time-aligned operations, the network may configure WTRUs so that their E-DCH subframes may be aligned on the uplink. Since the WTRUs may base their uplink reference on the downlink channel, different WTRUs in a cell may have different timing due to the difference in channel propagation. Since channel propagation differences may be measured at the Node-B, the Node-Bs may control the timing of each WTRU for which E-DCH time-alignment may be desired. The Node-Bs may align the timing of the transmissions of each WTRU that is configured to use a dedicated grant (e.g., WTRUs in different groups), such that they are configured to send information on the uplink within the same time period.

The WTRU may monitor timing advance signals from the Node-B. These timing advance indications or messages may be carried on an L1 (e.g., PHY layer) and/or an L2 (e.g., MAC layer) message. The WTRU may receive HS-SCCH orders or another indication on a channel(s) with timing advance commands. The timing advance command may include an index to a reference table that includes timing advance values. The WTRU may receive the order and/or may perform a look up in the table to determine the amount of timing advance to apply to its uplink transmission. The WTRU may apply the timing advance with regard to its downlink frame timing. The WTRU may apply the timing advance with regard to its current uplink frame timing. The timing advance may be applied a predefined time after the WTRU has sent the ACK after decoding the HS-SCCH order. The WTRU may apply the timing advance when the HS-SCCH order is received.

The uplink transmissions may be network-controlled. For usage of the uplink spectrum, the WTRU may use adaptive modulation coding (AMC) operations, which may be controlled by the network. Uplink operations, such as E-DCH operations, may exploit AMC indirectly through the serving grant. Larger grants may result in the WTRU being able to transmit with higher modulation schemes. While this technique may be effective from an overhead standpoint, it may use radio resources less efficiently than other techniques. In selecting the transport block (TB), the transport format (e.g., the number of channelization codes, spreading factor, modulation scheme, etc.), and/or the resulting code rate, the WTRU may take into account the channel conditions that may be experienced at the Node-B. Described herein are examples for such network-controlled uplink (e.g., E-DCH) transmissions, which may take into account conditions detected at the Node-B or other network entity.

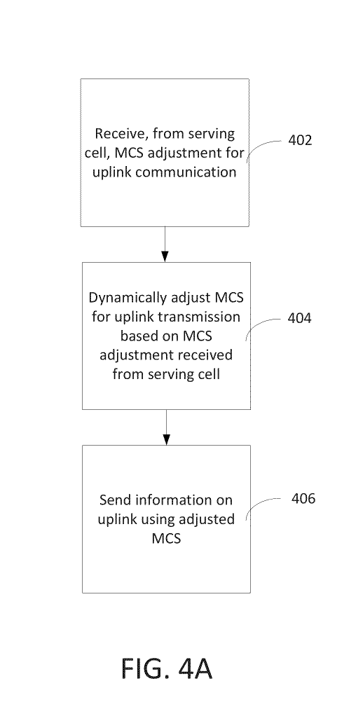

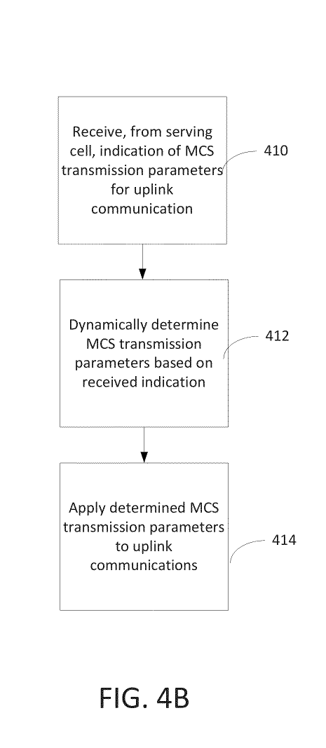

A network entity, such as a Node-B, may take into account conditions detected by the network and may control the modulation/coding scheme (MCS) at a WTRU. FIGS. 4A and 4B are flow diagrams that illustrate examples for controlling the MCS at a WTRU. FIG. 4A is a flow diagram that illustrates an example for adjusting MCS transmissions at a WTRU. An MCS adjustment may be performed to make adjustments to a transmission rate at a WTRU. Example conditions that may be considered for controlling MCS at the network may include channel state information, an interference level, a noise power, a WTRU path loss, and/or the like. As shown in FIG. 4A, a WTRU may receive an MCS adjustment from the serving cell at 402. The MCS adjustment may be received from the serving cell in response to conditions detected by the network. Based on the MCS adjustment received at 402, the WTRU may dynamically adjust the MCS for uplink transmissions at 404. The MCS adjustment may include an amount that one or more transmission parameters may be offset for uplink communications. The MCS adjustment may be made to adjust the power control at the WTRU. At 406, the WTRU may send information on the uplink using the adjusted MCS.

The MCS adjustment may refer to a gain factor adjustment or offset. The MCS adjustment may include a gain factor offset, a power offset, an index offset, and/or an E-DCH transport format combination identifier (E-TFCI) offset. The gain factor offset may be an offset that may be applied to the E-DCH Dedicated Physical Data Channel (E-DPDCH) gain factors, such as when determining the set of supported E-TFCs or for being applied to the reference gain factors in the E-TFC selection procedure. The power offset may be applied in a similar way and/or may be equivalent to the gain factor offset in the power domain. The index offset may be applied to the set of supported E-TFCI or to the index corresponding to the serving grant. The E-TFCI offset may be applied similarly to the index offset. The MCS adjustment may be implemented for dynamic MCS control. For AMC operations, the WTRU may receive a dynamic MCS adjustment from the uplink (e.g., E-DCH) serving cell. The WTRU may apply the dynamic MCS adjustment in the selection of the TB size (TBS).

The WTRU may receive the MCS adjustment at 402 from the uplink (e.g., E-DCH) serving Node-B. When the uplink channel includes the E-DCH, the WTRU may receive the MCS adjustment via an E-AGCH, an E-DCH rank and offset channel (E-ROCH), or other E-DCH control channel. The channel on which the MCS adjustment may be received may be based on an E-AGCH or an E-ROCH structure. The WTRU may apply the MCS adjustment in the calculation of the E-TFC selection and/or E-TFC restriction. The MCS adjustment may be applied to the reference E-TFCI power offset curves. The MCS adjustment may be applied dynamically.

The MCS adjustment may be applied at the E-TFC selection level (e.g., E-TFC selection and/or E-TFC restriction) by applying a power offset to the serving grant. When operating in this mode, the WTRU may refrain from transmitting the E-DPCCH, as the serving Node-B may not use this information for decoding the data (e.g., when the WTRU uses the TB/MCS as indicated by the Node-B). The serving Node-B may not use the data transmitted on the E-DPCCH when the WTRU is not in soft handover (SHO). When the WTRU is in SHO, the WTRU may transmit the E-DPCCH such that non-serving cells may decode the E-DPDCH. This may be implemented by adding an entry with a zero gain factor value in the E-DPCCH gain factor table and/or providing the signaling mechanism for the gain factor value in the RRC.

FIG. 4B is a flow diagram that illustrates an example for applying MCS parameters that are indicated by a network entity. The uplink (e.g., E-DCH) transmission parameters may be controlled dynamically. The dynamic parameter control may be performed using a number of parameters, such as a number of channelization codes and/or associated transport format (e.g., spreading factor) parameters, modulation parameters (e.g., BPSK, QPSK, 16QAM, 64QAM), TB size or associated code rate parameters, and/or retransmission sequence number (RSN) parameters. At 410, a WTRU may receive an indication of MCS transmission parameters from an uplink serving cell. At 412, the WTRU may dynamically determine the MCS parameters based on the received indication. The indication may include the MCS transmission parameters themselves, or may point to the location of the MCS transmission parameters that may be applied. The WTRU may include a table of MCS transmission parameters and the network entity may send an index value to the WTRU to perform a lookup in the table to locate the MCS transmission parameters indicated by the network entity. At 414, the WTRU may apply the determined MCS transmission parameters to its uplink communications.

The indication of the MCS transmission parameters may be received on a control channel. For dynamic control of uplink (e.g., E-DCH) transmission parameters when operating in AMC, the WTRU may receive a control channel carrying a set of one or more dynamic uplink (e.g., E-DCH) transmission parameters. The WTRU may apply the uplink (e.g., E-DCH) transmission parameters as directed by the Node-B. The uplink (e.g., E-DCH) transmission parameters may be applied at a fixed time after reception of the set of parameters. The WTRU may have some flexibility in selecting one or more uplink (e.g., E-DCH) parameters. The flexibility may depend on the WTRUs instantaneous headroom and/or buffer status. The WTRU may be configured to use a lower MCS if its headroom or its buffer may allow it.

TABLE 1 is an example of an indexed table that may be implemented at the WTRU for selecting parameters that may be implemented when performing uplink communications. The indexed table may be an MCS/TF table that may include a TBS, a transport format, and/or a modulation scheme that may be applied to the uplink. The MCS/TF table may be a pre-determined table stored at the WTRU.

TABLE 1
Example MCS/TF table

| MCS | | | Modulation |
|---|---|---|---|
| Index | TBS | Transport format | (per PhCH) |
| 0 | 18 | 1xSF128 | BPSK |
| 1 | 120 | 1xSF16 | BPSK |
| 2 | 352 | 1xSF8 | BPSK |
| 3 | 1084 | 2xSF4 | BPSK |
| . . . | . . . | . . . | . . . |
| 16 | 19241 | 2xSF2 + 2xSF4 | 4PAM |
| . . . | . . . | . . . | . . . |
| 30 | 30400 | 2xSF2 + 2xSF4 | 8PAM |
| 31 | 34507 | 2xSF2 + 2xSF4 | 8PAM |

The MCS table may be designed such that the data rates are linear with respect to the MCS indices or the data rates may be exponential with respect to the MCS indices. The WTRU may receive an indication of which TBS and/or MCS to use on a sub-frame-by-sub-frame basis from the Node-B. A grant channel (e.g., an E-AGCH channel or a channel based on an E-AGCH structure) may carry the MCS index that may be used as a lookup in the MCS/TF table. The WTRU may perform a lookup in the table to identify one or more parameters that may be applied to the uplink communications and may apply the associated parameters on the uplink. The associated parameters may be performed a predetermined amount of time after receiving the command from the Node-B. The WTRU may use the signaled TBS even if its buffer does not include sufficient data for the TBS. In such cases, the WTRU may pad the remaining bits with zeros.

The WTRU may receive an explicit command indicating a HARQ process number and/or an RSN to which the parameters may be applied. The channel on which the MCS index may be received may carry additional information, such as the RSN, a HARQ process number, a data indication, a retransmission indication, and/or the like. This channel may be referred to as the E-DCH MCS control channel (E-MCCH) when E-DCH is used as the uplink channel.

The WTRU may receive the E-MCCH channel and may process the information received on the E-MCCH. The E-MCCH may carry the MCS index (e.g., 5-6 bits), a data indication (e.g., 1 bit), and/or an E-RNTI or other RNTI value, which may be coded in the E-AGCH. Upon reception of the E-MCCH channel, the WTRU may determine if it is the intended destination of the information on the channel. To determine if it is the intended destination, the WTRU may use the received RNTI value. The WTRU may check the CRC with the configured RNTI. If the WTRU is the intended destination, the WTRU may apply the control to the associated E-DCH transmission and/or HARQ process(es).

When there is a HARQ retransmission and/or the WTRU receives an E-MCCH associated with the HARQ process(es), the WTRU may read the data indication bit on the E-MCCH. The data indication bit may indicate to the WTRU whether the Node-B received the data transmitted on the previous uplink transmission. The data indication bit may indicate that additional data is to be transmitted. The WTRU may begin another transmission of previously untransmitted data upon receipt of the data indication bit. When the data indication bit is set to true, the WTRU may discard the data in the associated HARQ process buffer and/or restart another transmission. When another transmission is restarted, the RSN may be reset. When the data indication bit is set to false, the WTRU may retransmit the data in the HARQ process buffer. The data may be retransmitted using the modulation scheme indicated by the MCS index. When the data indication bit is set to false, the WTRU may increment the RSN value to keep track of the number of lost or improperly received transmissions, or to ensure proper synchronization of RSN with the Node-B. When there is a HARQ retransmission and/or the WTRU does not receive an E-MCCH, the WTRU may perform a HARQ retransmission using the MCS of the last transmission for that HARQ process and/or update the RSN appropriately.

A WTRU configured to operate according to AMC operation may adjust its transmission power level. The WTRU may perform power control by adjusting the transmission power setting of the DPCCH, the transmission power of the WTRU, and/or the maximum transmission power of the WTRU. The WTRU may adjust its transmission power level based on an absolute value received from the network. The absolute value may be received via RRC signaling. The signaling of the absolute value to the WTRU may allow the network (e.g., at the RNC) to control the amount of interference generated to non-serving Node-Bs. The transmission power level may be adjusted based on interference reports from the non-serving Node-Bs and/or received power measurements reports from the WTRU. The transmission power level of a WTRU may be decreased when the interference at a non-serving Node-B exceeds a predetermined threshold and/or the transmissions from a WTRU are received at a power level above a predetermined threshold.

The WTRU may be configured with one or more absolute transmit power values. The absolute transmit power value may define the WTRU transmit power. The WTRU may be configured with an absolute DPCCH power value. The absolute DPCCH power value may be in units of dBm or Watts. The absolute transmit power value may be indexed in a pre-defined table that may be stored on the WTRU.

The WTRU may be configured with one or more gain factors. The gain factors may be fixed for control channels and/or data channels. The control channels may include an HS-DPCCH, an E-DPCCH, and/or the like. The data channels may include an E-DPDCH and/or the like.

The transmission power value or gain value may be a value provided to the WTRU in a transmission power message and may be applied after reception of the message. A transmission power value that is implemented at the WTRU may remain valid until reception of another transmission power message. The values received in subsequent messages may be expressed in absolute terms, or in relative terms from the previously implemented transmission power value. The relative transmission power value may be indicated in terms of a number of dBs above or below the previously implemented value. The transmission power messages may allow the network to reduce the WTRU power in case of interference or signal overload at one of the Node-Bs.

The WTRU may be provided with more than one transmission power value (e.g., two values) within a message. The WTRU may dynamically select the value to use based on physical layer and/or MAC layer signaling. The WTRU may select a value within the transmission power message when a power reduction command has been received (e.g., within a period of time). If the power reduction command has not been received within a defined period of time, another value within the transmission power message may be selected. The power values may be received in the same transmission power message, may be disbursed across messages, and/or may be stored locally for lookup. The period of time in which the power reduction command may be received may have a fixed duration. The period of time in which the power reduction command may be received may begin at the reception of the last RRC message that includes the power transmission values. The power reduction command may be signaled as a serving or non-serving grant channel, such as an E-RGCH.

The WTRU may use a transmission power value indicated in a transmission power message upon reception of the RRC message. The transmission power value may be a value in the transmission power message or another value indicated via the RRC message. The transmission power value may be the first value in the transmission power message, such as where multiple values may be configured simultaneously. Upon reception of a power reduction command, a WTRU may reduce its power value incrementally. A WTRU using an Nth power value may reduce its power value by using the N+1th power value or the next lowest power value. The transmission power value may be decremented until the lowest power value provided to the WTRU has been reached. After reception of the RRC signaling, the WTRU may update its transmission power based on fixed step power adjustments (e.g., up or down by N dB) based on physical layer or MAC signaling. The updated transmission power may be subject to minimum and/or maximum values provided in the RRC signaling.

The WTRU may set its transmission power based on at least one measurement of the received power from at least one cell (e.g., CPICH RSCP) and/or on at least one offset value received from the network. This may allow the network to maximize the WTRU transmission power subject to maintaining its inter-cell interference contribution within a threshold. The transmission power may be set according to the following formula:

P=min[Pmax, min(Offset−RSCP_{—}i)], Equation 1

where RSCP_i may represent the measured received signal code power from the ith cell in dBm, Offset may be an offset value in dB, and/or Pmax may be a maximum power in dBm. The set of cells from which the received power may be measured may be explicitly configured from RRC signaling. The set of cells may correspond to the subset of cells in the active set of the WTRU, but may be absent from the serving E-DCH set. The measurement estimates of RSCP_i may be updated periodically. The periodical update may occur each 100 ms or 200 ms, for example. The value of the Offset may be selected in a similar manner to the adjustment based on absolute power levels. The power reduction commands may be conveyed through a non-serving grant channel, such as E-RGCH, to back off the transmission power of the WTRU until an RRC message may be transmitted.

The WTRU may indicate to the network the difference between the currently used value of the transmit power and a maximum transmit power value. This difference may be referred to as the power headroom. The maximum value may be determined according to a WTRU capability or a maximum value provided by the network. Such an indication of the power headroom may be conveyed directly to the serving Node-B through MAC signaling. The indication of the power headroom may be sent to the WTRU as part of the scheduling information (SI). The WTRU may indicate the headroom in the UE transmission power headroom (UPH) field of the SI. The headroom may be signaled by RRC to the RNC.

Pilot boosting may be applied by the WTRU. The WTRU may apply pilot boosting directly to the control channel. The control channel may include the DPCCH. The pilot boosting may be applied to the DPCCH when such application is determined from the power level and/or modulation of the E-DPDCH. The pilot boosting may be applied when the WTRU is configured with a fixed DPCCH baseline power. The WTRU may apply a boosting factor to the DPCCH power based on the E-DPDCH transport format, the E-DPDCH modulation scheme, the E-DPDCH code rate, the E-TFCI value, and/or the E-DPDCH power. The boosting factor may increase the DPCCH power a factor above the baseline power. In this mode of operation, the WTRU may prevent transmission of the DPCCH when there is no data or E-DPDCH transmitted in a specific slot.

The WTRU may be configured with one or more DPCCH boosting factors. The DPCCH boosting factors may be stored at the WTRU in a table. Each boosting factor may be associated to an E-TFCI index or threshold. The WTRU may determine the appropriate DPCCH boosting factor by comparing the candidate E-TFCI to the stored entries at the WTRU. The WTRU may determine the DPCCH boosting factor associated with the highest E-TFCI index in the table that is lower than the candidate E-TFCI.

A non-scheduled grant may be used and/or controlled as described herein. The RNC may configure a WTRU with non-scheduled grants that may be used on a semi-static or long-term basis. The configuration of a HARQ process with a non-scheduled grant may give the HARQ process a right to transmit a predefined amount of information (e.g., predefined number of bits), regardless of the scheduled grant configuration. A HARQ processes configured with a non-scheduled grant may transmit on the uplink even if the scheduled serving grant value is set to zero. The non-scheduled grants may be controlled by the RNC and may be unaffected by the Node-B scheduler that may be configuring the scheduled serving grants.

The non-scheduled HARQ process transmissions may be dynamically controlled. The WTRU may be configured with non-scheduled grants and/or the allowed HARQ process in which the non-scheduled grants may be transmitted. The use of the non-scheduled grant and/or HARQ process may be dynamically controlled in the WTRU. The WTRU may operate in an active non-scheduled transmission mode and/or an inactive non-scheduled transmission mode. An active non-scheduled transmission mode may refer to a mode of operation in which the WTRU may use the non-scheduled grant and/or the RRC configured HARQ processes to transmit non-scheduled data. Inactive non-scheduled transmission mode may refer to a mode of operation in which the WTRU, even though it may be configured with non-scheduled grants and/or allowed non-scheduled HARQ processes by RRC configuration, may be unable to use each of the configured resources or HARQ processes (e.g., the WTRU may not be allowed to use each of the configured resources or HARQ processes at all times).

The network may be aware that the WTRU may not be using each of the configured non-scheduled HARQ processes. During this time, the network may use the resources for scheduled data and/or provide a higher serving grant without the risk of exceeding the noise rise budget. When the network is aware that the WTRU may have unused non-scheduled HARQ processes, the network may allow the use of the non-scheduled grants for scheduled data.

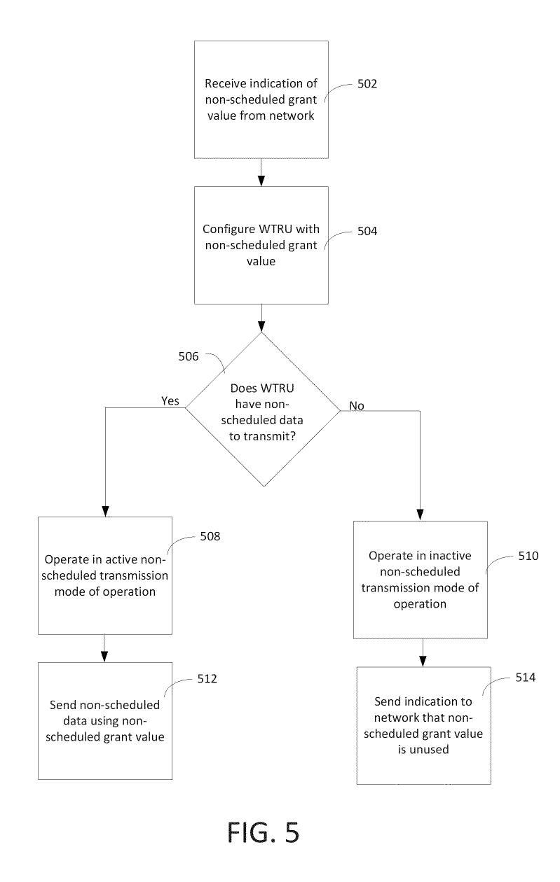

FIG. 5 is a flow diagram that illustrates an example for operating in different non-scheduled transmission modes. The different non-scheduled transmission modes of operation may be implemented at a WTRU. As shown in FIG. 5, a non-scheduled grant value may be indicated by a network entity at 502. The non-scheduled grant value may be indicated at 502 via dedicated RRC signaling. At 504, the WTRU may be configured with the non-scheduled grant value. One or more HARQ processes on the WTRU may be configured to perform transmissions using the non-scheduled grant value. Multiple HARQ processes may be configured with the same non-scheduled grant value, or each HARQ process may be configured with a different non-scheduled grant value. The configuration of a HARQ process with a non-scheduled grant may give the HARQ process a right to transmit a predefined amount of information (e.g., predefined number of bits), regardless of the scheduled grant configuration.

At 506, the WTRU may determine whether the WTRU has non-scheduled data for being transmitted. The WTRU's buffer may be examined at the expiration of a period of time or over a period of time to determine whether the buffer has any non-scheduled data for being transmitted. The buffer may be associated with one or more HARQ processes at the WTRU. If the WTRU has non-scheduled data for transmission at 506, an active non-scheduled transmission mode of operation may be implemented at 508. If the WTRU does not have non-scheduled data for being transmitted at 506, an inactive non-scheduled transmission mode of operation may be implemented at 510.

In the active non-scheduled transmission mode of operation, non-scheduled data may be sent, at 512, from the WTRU to the network using the non-scheduled grant value. A HARQ process or HARQ processes configured with the non-scheduled grant value may send information using the non-scheduled grant value. In the inactive non-scheduled transmission mode of operation, an indication may be sent, at 514, from the WTRU to the network indicating that the non-scheduled grant value is unused. The network may use the resources reserved for the non-scheduled grant at the WTRU to schedule other transmissions. While the WTRU may operate in inactive non-scheduled transmission mode for one or more HARQ processes, other HARQ processes may send information using non-scheduled transmissions. The WTRU may indicate to the network when the non-scheduled grant value may be used again. In another example, the WTRU and the network may be configured to operate in inactive non-scheduled transmission mode for a specified amount of time, after which the active non-scheduled transmission mode of operations may resume.

During inactive non-scheduled transmission mode of operation the WTRU may use a HARQ process, or a subset of the configured HARQ processes, for non-scheduled transmissions. This may be referred to as an active HARQ process(es) for non-scheduled transmissions. The WTRU may determine the active HARQ process in which it may be allowed to perform non-scheduled transmission. The active HARQ process may be determined according to an explicit HARQ process ID configured for non-scheduled transmission during inactive non-scheduled transmission mode of operation and/or a bit map of allowed active HARQ processes. The HARQ processes may correspond to a HARQ process that may be active when needed (e.g., a HARQ process that may always be active).

The WTRU may determine the active HARQ process in which it may be allowed to perform non-scheduled transmissions according to a non-scheduled offset and/or a non-scheduled cycle. The non-scheduled offset and/or non-scheduled cycle may be configured in the WTRU. The WTRU may perform non-scheduled transmission on a TTI that meets the following criteria: [5*CFN+subframe number−UE non-scheduled offset] mod non-scheduled Cycle=0, where the CFN may be the connection frame number, the subframe number may be the subframe number in a frame, the UE non-scheduled offset may indicate a TTI within a cycle, and the non-scheduled Cycle may indicate a number of TTIs within a cycle. The UE non-scheduled offset and the non-scheduled cycle may be parameters configured by the network via RRC signaling. When this equation is true, a WTRU may perform non-scheduled transmission.

The WTRU may determine the active HARQ process in which it may be allowed to perform non-scheduled transmission based on lower-layer signaling. The lower-layer signaling may be used to indicate active and/or inactive non-scheduled HARQ processes. L1 HS-SCCH orders and/or E-AGCH signaling, or similar grant channel signaling, may be used to activate a HARQ process, a subset of HARQ processes, or each HARQ process that may be allowed to be activated/deactivated. A MAC control element, which may be included in a MAC-level header, may be used to control the HARQ processes.

A WTRU may be operating in an active non-scheduled transmission mode and may move to inactive non-scheduled transmission mode of operation when one or more triggers are met. A dynamic explicit message may be used to control the activation status of non-scheduled HARQ processes in the WTRU. The message may move the WTRU to inactive non-scheduled transmission mode of operation. The message may explicitly deactivate HARQ processes from transmitting non-scheduled data. The message may include an L1 HS-SCCH order, an L1 E-AGCH message, or similar grant channel message, an L2 MAC message, and/or a higher layer RRC message. The L1 HS-SCCH order may indicate deactivation of each non-scheduled HARQ process, or a subset of non-scheduled HARQ processes. The indication may be an explicit indication of a HARQ process to deactivate, or an indication of each HARQ process except a HARQ process configured by the network to be active. An L1 E-AGCH message, or similar grant channel message, may indicate deactivation of each non-scheduled HARQ process, or a subset of non-scheduled HARQ processes. The indication may be an explicit indication of a HARQ process to deactivate, or an indication of each HARQ process except a HARQ process configured by the network to be active. An L2 MAC message may include a MAC control message that may include a similar indication as described herein for the L1 HS-SCCH order or other L1 message.

A WTRU may move to an inactive non-scheduled transmission mode of operation based on a level of non-scheduled data activity. If the WTRU has failed to transmit non-scheduled data for a predetermined period of time and/or no non-scheduled data may be available in the buffer, the WTRU may transition to an inactive non-scheduled transmission mode of operation. The inactivity period may be monitored for each non-scheduled transmission on any of the allowed HARQ processes. The inactivity period may be monitored with respect to the active HARQ process or HARQ processes.

The WTRU may autonomously transition to inactive non-scheduled transmission mode when inactivity is detected. Upon detection of inactivity, the WTRU may notify the network of the inactivity and/or transition to active non-scheduled transmission mode. The WTRU may transition to active non-scheduled transmission mode upon receipt of an explicit indication, autonomously, or upon acknowledgment of receipt of the message sent to the network. The message used to inform the network of the inactivity may be carried in a field of the scheduling information, a MAC message, and/or an RRC message. The field of the scheduling information may be used to indicate a value of the LCID or the LCH ID corresponding to a logical channel configured for non-scheduled transmission. The WTRU may set the corresponding buffer status (e.g., TEBS) to zero.

A WTRU operating in an inactive non-scheduled transmission mode of operation may transition to an active non-scheduled transmission mode. An explicit activation message may be received, which may indicate activation of each non-scheduled HARQ process or explicit HARQ processes to activate. The message may include an L1 HS-SCCH order, an L1 E-AGCH message, or similar grant channel message, an L2 MAC message (e.g., an MAC control message), and/or a higher layer RRC message.

A WTRU may transition to an active non-scheduled transmission mode when non-scheduled data arrives and/or non-scheduled transmission may be performed on allowed HARQ processes. The WTRU may transition to active non-scheduled transmission mode when the first transmission takes place in the allowed special HARQ process. The transition to active non-scheduled transmission mode may take place when the transmission has been acknowledged by the network.

The WTRU may send an indication to the network to request an activation of the non-scheduled grants and HARQ processes. The WTRU may begin transition to active non-scheduled transmission when the explicit indication is received and/or the request has been acknowledged by the network. The request may correspond to scheduling information, a MAC message, and/or an RRC message. The scheduling information may indicate that a non-scheduled transmission is present. The scheduling information may indicate that a non-scheduled transmission is present using a value of the LCH ID, or an LCH ID that may correspond to the non-scheduled data and/or the equivalent buffer status for non-scheduled transmission.

Non-scheduled allocated resources may be used as described herein. The WTRU may use the non-scheduled grants, or a subset thereof, for scheduled data transmission. The non-scheduled grants, or the subset thereof, may be used for scheduled data to optimize the use of the non-scheduled allocated resources. The WTRU may utilize the non-scheduled grant for scheduled transmission when configured. The WTRU may determine to utilize the non-scheduled grant for scheduled transmission when the non-scheduled grant for a MAC flow (e.g., MAC-d flows) is unused, when the non-scheduled grant for the MAC flows allowed to be multiplexed in the given TTI are unused, and/or when the WTRU is operating in an inactive non-scheduled transmission mode of operation. When the WTRU is operating in an inactive non-scheduled transmission mode of operation, the WTRU may use the non-scheduled grant of each of the HARQ processes that may be configured with non-scheduled transmission and that may not be allowed to transmit for scheduled data. The HARQ process may not be used for scheduled data and the non-scheduled grants may not be used for scheduled data in that HARQ process.

The WTRU may determine to use the un-used non-scheduled grant for scheduled data. The WTRU may determine the number of bits that may be transmitted in the given TTI for the allowed non-scheduled MAC (e.g., MAC-d) flows (e.g., allowed non-scheduled bits) as the sum of non-scheduled grants across the allowed MAC flows. Allowed MAC flows may correspond to the MAC flows that may be multiplexed with the highest priority MAC flow in a given TTI, each of the non-scheduled MAC flows, each of the MAC flows that have no data for transmission in a given TTI, and/or each of the MAC flows in the multiplexing list without data for transmission in a given TTI.

When performing E-TFC selection in the WTRU, the WTRU may check the remaining available number of unused non-scheduled bits. The WTRU may attempt to complete E-TFC selection according to other procedures (e.g., legacy E-TFC selection procedures), including each of the non-scheduled MAC flows. The WTRU may determine if the scheduled grant allowed is exceeded. The WTRU may calculate the remaining available number of unused non-scheduled bits. The E-TFC selection may be performed by subtracting the number of non-scheduled bits included in the MAC PDU from the calculated non-scheduled bits. The remaining value may be used by the WTRU to transmit scheduled data.

The WTRU may add up the number of allowed scheduled and/or non-scheduled bits and may use the calculated value for E-TFC selection. The WTRU may use the calculated value as the maximum value that may be used for scheduled data and/or non-scheduled data in the E-TFC selection procedure. The WTRU may not be bound by the number of allowed scheduled bits from the serving grant. The use of the calculated value may depend on the remaining bits and/or priority of data. This use of the calculated value for E-TFC selection may result in non-scheduled transmissions not being transmitted due to scheduled data having a higher priority.

The number of allowed scheduled bits may be calculated by adding the total number of scheduled bits from a serving grant with the allowed non-scheduled bits and subtracting the number of non-scheduled bits for the MAC (e.g., MAC-d) flows that may be transmitted in the TTI. The upper bound for scheduled data may include the calculated value.

If the allowed non-scheduled bits are calculated as the allowed MAC (e.g., MAC-d) flows for which data is not available in the TTI, the WTRU may determine the total number of scheduled bits that may be transmitted as the maximum number of scheduled bits from the serving grant plus the allowed non-scheduled bits.

The serving grant may be used to determine the upper bound of scheduled and/or non-scheduled bits. The network may use the serving grant to control the total power that the WTRU may use for scheduled and/or non-scheduled data. The WTRU may be configured with a non-scheduled grant. The number of bits that may be used for scheduled data may correspond to the full serving grant. The number of bits that may be used for scheduled data may correspond to the serving grant bits minus the non-scheduled bits, or the equivalent of the non-scheduled bits in the unit of power ratio.

The WTRU may determine the total number of scheduled bits it may transmit. The total number of scheduled bits may be determined by the serving grant minus the total available non-scheduled bits available in the buffer for the MAC (e.g., MAC-d) flows allowed to be multiplexed in a TTI up to non-scheduled grant for the MAC flow. The total number of scheduled bits as determined by the serving grant may be the total number of bits that may be transmitted in the MAC (e.g., MAC-d) PDU and/or the total number of scheduled bits. E-TFC selection may be performed in the order of priority of MAC (e.g., MAC-d) flows. If non-scheduled MAC (e.g., MAC-d) flows are available and/or have higher priority than scheduled flows, the non-scheduled MAC (e.g., MAC-d) bits up to an available non-scheduled grant may be included. The power limitations may be the upper bound of E-TFC selection.

The WTRU may utilize the serving grant as an upper limit for each transmission and/or for scheduled transmissions upon configuration. The WTRU may utilize the serving grant when the non-scheduled grant for any of the MAC (e.g., MAC-d) flows is unused. The WTRU may utilize the serving grant when the non-scheduled grant for the MAC (e.g., MAC-d) flows allowed to be multiplexed in the given TTI are unused. The WTRU may utilize the serving grant when the WTRU is operating in inactive non-scheduled transmission mode of operation. When the WTRU is operating in inactive non-scheduled transmission mode of operation, the WTRU may use the non-scheduled grant of each HARQ process configured with non-scheduled transmission but not allowed to transmit for scheduled data. The HARQ process may not be used for scheduled data. The non-scheduled grants may not be used for scheduled data in the HARQ process.

A grant operation may be shared for non-scheduled and scheduled data. The WTRU may be configured with non-scheduled and/or scheduled data. A common grant may be used for non-scheduled and scheduled data, or each type of data may be treated as scheduled data. Some non-scheduled data may be delay sensitive. The delay sensitivity may be taken into consideration to request service and/or minimize signaling.

To allow the WTRU to request resources for non-scheduled transmissions and/or delay sensitive transmissions, which may be referred to as non-scheduled data, the WTRU may use the SI to notify the network. SI triggers may be implemented as described herein. When SG=0 and non-scheduled data arrives, the WTRU may be triggered to send SI to the network. When SG<>0, if non-scheduled data arrives and/or the WTRU is transmitting scheduled data, the WTRU may be triggered to send SI to the network. The SI may be triggered even if non-scheduled data is lower priority than the scheduled data in the buffer.

The request for a grant for non-scheduled data may take the form of a MAC control PDU or MAC PDU. The WTRU may indicate the non-scheduled transmission logical channel priority and/or the amount of data in the MAC control PDU or MAC PDU. The SI transmitted to the network may include an indication that it was triggered due to non-scheduled transmissions. The total E-DCH buffer status (TEBS) may include non-scheduled data in the TEBS calculation. The highest logical channel ID may correspond to the logical channel ID of the non-scheduled data. The buffer status of the non-scheduled transmission may be included as a separate field. The buffer status of the non-scheduled transmission may be included in the field where the buffer status of the highest logical channel is indicated.

Uplink load balancing may be performed as described herein. Uplink load balancing may be performed for a WTRU that supports uplink communication using multiple frequencies (e.g., DC-HSUPA or multi-cell HSUPA). When multiple active smartphones or other WTRUs reside in the same cell, uplink load balancing may be performed by the network to manage the data packets being transmitted. The data packets may be transmitted in an unpredictable way. Dynamic load balancing mechanisms may be implemented for data packets that may avoid using extensive control signaling.

To carry out dynamic load balancing, the WTRU may be pre-configured with a set of uplink transmission parameters for the source uplink frequency and the target uplink frequency. The WTRU may be configured with a set of parameters for a downlink frequency handover that may occur simultaneously. This set of pre-configuration messages may be carried over RRC signaling and may originate from the RNC. The RNC may preconfigure the Node-B over the Iub.

Various triggers and/or WTRU actions may be implemented when performing dynamic frequency handover. Although the embodiments described herein may be described in the context of the uplink, these embodiments may also be applicable to the downlink. As a WTRU may carry out downlink frequency handover at the same time as the uplink frequency handover, some actions and/or triggers related to downlink frequency handover may take place when reading actions related to uplink frequency handover.

The WTRU may execute a dynamic uplink frequency handover following one or more received triggers. The triggers may include an HS-SCCH order with an indication for uplink frequency handover, a value signaled on the E-AGCH, or other grant channel, indicating an uplink frequency handover, and/or an indication in a MAC (e.g., MAC-hs or MAC-ehs) header. When the value signaled on the E-AGCH is used to indicate an uplink frequency handover, the WTRU may be configured with a value in the absolute serving grant table and/or an E-RNTI. When the E-RNTI value is detected, the uplink frequency handover may be triggered.

After detecting the trigger, the WTRU may apply the configuration, perform the uplink frequency handover, and/or perform the associated downlink frequency handover. The WTRU may execute the uplink frequency handover after one or more ongoing HARQ processes have completed. A HARQ process may be completed when the WTRU has received an ACK from the network or the maximum number of transmissions is reached.

The WTRU may detect a dynamic uplink frequency handover trigger and may begin a dynamic uplink frequency handover. The trigger may cause the WTRU to stop creating transmissions and/or wait for HARQ processes to complete before the uplink frequency handover is executed. The creation of the transmissions may be stopped by setting the serving grant to zero upon detection of the trigger and/or stopping execution of E-TFC selection. The WTRU may stop listening and/or applying the grants signaled by the network.

The WTRU may execute the uplink frequency handover a predetermined amount of time after the trigger. The WTRU may detect a dynamic uplink frequency handover trigger and may start a timer. The WTRU may stop creating transmissions and may wait for a timer to expire. The WTRU may execute the uplink frequency handover upon expiration of the timer. The WTRU may stop creating transmissions by setting the serving grant to zero upon detection of the trigger and/or stopping execution of E-TFC selection. The WTRU may stop listening and/or applying the grants signaled by the network.

The WTRU may execute the uplink frequency handover and/or other WTRU processes described herein upon detection of the trigger. The WTRU may stop ongoing HARQ retransmissions and/or flush the HARQ buffer after detection of the trigger. Stopping ongoing HARQ retransmissions and/or flushing the HARQ buffer may cause loss of the ongoing transmissions, which may lead to additional latency. While additional latency may be incurred, the WTRU may not have sufficient grant on the uplink frequency for the ongoing transmissions. The WTRU may detect a dynamic uplink frequency handover trigger and may begin uplink frequency handover. The WTRU may flush the HARQ memory and/or reset HARQ processes before or after the uplink frequency handover is executed.

The WTRU may halt ongoing HARQ retransmissions and/or resume the HARQ retransmissions after the handover is completed. This may lead to lower latency as HARQ transmissions may not be dropped. The WTRU may detect a dynamic uplink frequency handover trigger and execute the uplink frequency handover. The trigger may cause the WTRU to stop HARQ transmissions. The HARQ transmissions may be stopped before the handover is completed. The WTRU may resume the HARQ transmissions after the handover is completed. When the WTRU stops HARQ transmissions, it may keep the HARQ memory and/or state for each HARQ process. The WTRU may execute a downlink handover when executing the uplink handover.

The WTRU may resume transmission in the uplink frequency. The WTRU may perform a synchronization procedure for initiating uplink transmission on the frequency. The WTRU may transmit with the same, or similar, uplink power as it was transmitting in the originating frequency. The WTRU may apply a power offset to the initial transmit power. The WTRU may perform a synchronization procedure with post-verification when executing a dynamic uplink frequency handover.

When performing the uplink frequency handover, the WTRU may use the same serving grant. As the uplink noise rise and interference conditions may be different on each frequency, the WTRU may be configured with an initial default grant to apply on the frequency (e.g., subsequent or changed frequency). The WTRU may monitor the E-AGCH for another grant. The WTRU may have a default grant of zero when changing uplink frequency and/or may start transmitting E-DCH on the changed uplink frequency, for example, once it gets a grant via the E-AGCH.

Although features and elements are described above in particular combinations or implementations, each feature or element may be used as examples and may be used alone or in any combination with other features and elements. While some channel types may be used as examples, such as E-DCH, other channels types may be similarly implemented. Additionally, while features and elements are described in a particular order, these features and elements are not limited to the order described. Further, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, terminal, base station, RNC, or any host computer.

What is claimed:

1. A method for controlling an uplink transmit power on a wireless transmit/receive unit (WTRU), the method comprising:
receiving, via a grant channel, a group identifier and a WTRU identifier, wherein the group identifier indicates a group of WTRUs that share a dedicated grant on an uplink channel, and wherein the WTRU identifier indicates which WTRU within the group of WTRUs is allowed to use the dedicated grant on the uplink channel;
determining whether the group identifier and the WTRU identifier are associated with the WTRU; and
determining, based on whether the group identifier and the WTRU identifier are associated with the WTRU, whether to send information on the uplink channel using the dedicated grant.

2. The method of claim 1, further comprising sending the information on the uplink channel when the group identifier and the WTRU identifier are associated with the WTRU.

3. The method of claim 1, further comprising, when at least one of the group identifier or the WTRU identifier are not associated with the WTRU, refraining from sending the information on the uplink channel using the dedicated grant.

4. The method of claim 3, further comprising sending the information on the uplink channel using another serving grant.

5. The method of claim 1, wherein when the group identifier and the WTRU identifier are associated with the WTRU, the WTRU is allowed to send the information on the uplink channel until the WTRU receives a second group identifier and determines that the second group identifier is not associated with the WTRU.

6. The method of claim 1, wherein the WTRU is allowed to use the dedicated grant on the uplink channel during a same time period as a second WTRU that is in a second group of WTRUs.

7. The method of claim 1, further comprising:
receiving an activation trigger associated with the WTRU identifier; and
when the group identifier and the WTRU identifier are associated with the WTRU, using the activation trigger to trigger the sending of the information on the uplink channel using the dedicated grant.

8. The method of claim 1, wherein the uplink channel includes an enhanced dedicated channel (E-DCH), wherein the grant channel includes an E-DCH absolute grant channel (E-AGCH), and wherein the group identifier includes an E-DCH radio network temporary identity (E-RNTI) value.

9. The method of claim 1, wherein the dedicated grant includes an HARQ-process dependent serving grant (HSG) that is associated with one or more HARQ processes at the WTRU.

10. The method of claim 9, wherein each HARQ process of the one or more HARQ processes is configured with a corresponding HSG.

11. A WTRU for controlling an uplink transmit power, the WTRU comprising:
a processor configured to:
receive, via a grant channel, a group identifier and a WTRU identifier, wherein the group identifier indicates a group of WTRUs that share a dedicated grant on an uplink channel, and wherein the WTRU identifier indicates which WTRU within the group of WTRUs is allowed to use the dedicated grant on the uplink channel;
determine whether the group identifier and the WTRU identifier are associated with the WTRU; and
determine, based on whether the group identifier and the WTRU identifier are associated with the WTRU, whether to send information on the uplink channel using the dedicated grant.

12. The WTRU of claim 11, wherein the processor is further configured to send the information for transmission on the uplink channel when the group identifier and the WTRU identifier are associated with the WTRU.

13. The WTRU of claim 11, further comprising, when at least one of the group identifier or the WTRU identifier are not associated with the WTRU, refraining from sending the information for transmission on the uplink channel using the dedicated grant.

14. The WTRU of claim 13, wherein the processor is further configured to send the information for transmission on the uplink channel using another serving grant.

15. The WTRU of claim 11, wherein when the group identifier and the WTRU identifier are associated with the WTRU, the processor is configured to send the information for transmission on the uplink channel until the processor receives a second group identifier and determines that the second group identifier is not associated with the WTRU.

16. The WTRU of claim 11, wherein the WTRU is allowed to use the dedicated grant on the uplink channel during a same time period as a second WTRU that is in a second group of WTRUs.

17. The WTRU of claim 11, wherein the processor is further configured to:
receive an activation trigger associated with the WTRU identifier; and
when the group identifier and the WTRU identifier are associated with the WTRU, use the activation trigger to trigger the sending of the information for transmission on the uplink channel using the dedicated grant.

18. The WTRU of claim 11, wherein the uplink channel includes an enhanced dedicated channel (E-DCH), wherein the grant channel includes an E-DCH absolute grant channel (E-AGCH), and wherein the group identifier includes an E-DCH radio network temporary identity (E-RNTI) value.

19. The WTRU of claim 11, wherein the dedicated grant includes an HARQ-process dependent serving grant (HSG) that is associated with one or more HARQ processes at the WTRU.

20. The WTRU of claim 19, wherein each HARQ process of the one or more HARQ processes is configured with a corresponding HSG.
